(19) United States
(12) Patent Application Publication
(10) Pub. No.: US 2013/0136413 A1
(43) Pub. Date: May 30, 2013

(54) PLAYBACK APPARATUS, CONTROL METHOD AND RECORDING MEDIUM

(71) Applicant: Canon Kabushiki Kaisha, Tokyo (JP)

(72) Inventor: Takashi Mizuno, Tokyo (JP)

(73) Assignee: CANON KABUSHIKI KAISHA, Tokyo (JP)

(21) Appl. No.: 13/670,576

(22) Filed: Nov. 7, 2012

(30) Foreign Application Priority Data
Nov. 25, 2011 (JP) 2011-258216

(51) Int. Cl. H04N 5/783; H04N 5/775; H04N 9/80

(52) U.S. Cl. 386/230; 386/241; 386/E05.052; 386/E09.011; 386/E05.07

(57) ABSTRACT

A playback apparatus obtains section information, which is included in obtained moving image data, and includes a shooting frame rate, information required to identify a start frame, and information of a range of an elapsed time from a shooting start timing for each section having the same shooting frame rate. When a playback position of the moving image data is specified using an elapsed time from the shooting start timing, the playback apparatus determines a section including the playback position using pieces of section information of respective sections. Then, the playback apparatus identifies a playback frame corresponding to the playback position from information of a range of an elapsed time of the determined section, a shooting frame rate of that section, information required to identify a start frame of that section, and the playback position.

### BACKGROUND OF THE INVENTION

1. Field of the Invention

The present invention relates to a playback apparatus, control method, and recording medium, and more particularly, to a playback technique of moving image data, which includes a range captured at a shooting frame rate different from a playback frame rate.

2. Description of the Related Art

Image capture apparatuses such as digital video cameras and digital cameras include those which can change the number of frame images to be obtained per sec (to be referred to as a shooting frame rate hereinafter) during a moving image shooting operation.

On the other hand, when moving image data is played back by a playback apparatus, the number of frame images to be read out per sec (to be referred to as a playback frame rate hereinafter) is set. In general, the playback frame rate assumes a fixed value. When a moving image captured by an image capture apparatus is to be played back, motions of subjects can be reproduced to have the same time progress as that upon shooting by setting the shooting frame rate of the moving image to be equal to the playback frame rate.

In contrast, when moving image data, which is obtained by changing the shooting frame rate during shooting, as described above, is to be played back, motions of subjects are reproduced to have time progress different from that upon shooting when frames in a range captured at a shooting frame rate different from the playback frame rate are played back. For example, a case will be examined below wherein moving image data including a range in which the user switched the shooting frame rate from 60 fps to 120 fps for 10 sec to capture a moving image during shooting is played back by a playback apparatus having a playback frame rate of 60 fps. At this time, a time required to play back that range is 10 sec×(120 fps/60 fps)=20 sec. That is, since moving image data captured for 10 sec is played back to spend 20 sec, a so-called slow-motion effect is given to a viewer.

Note that when moving image data including a range captured at a different shooting frame rate is to be played back, the viewer may often feel as if the playback speed were changing abruptly when the playback position enters that range. Japanese Patent Laid-Open Nos. 2006-254366 and 2007-166501 disclose techniques for notifying the viewer of such changes by identifiably displaying the range of the different shooting frame rates on a sequence bar, which is displayed upon playing back such moving image data, and indicates an elapsed time.

However, the sequence bar, which is displayed when a playback apparatus disclosed in Japanese Patent Laid-Open Nos. 2006-254366 and 2007-166501 plays back moving image data, is set to have a time required to play back moving image data as a maximum elapsed time. For example, a case will be examined below wherein one moving image data obtained by a shooting operation for 34 min at a shooting frame rate of 30 fps and then by a shooting operation for 6 min while the shooting frame rate was switched to 120 fps is to be played back by a playback apparatus having a playback frame rate of 30 fps. At this time, a maximum elapsed time of the sequence bar, which is displayed on a playback screen of the moving image data, is set to be 34 min+6 min×120 fps/30 fps=58 min as a time required for actual playback in place of 34 min+6 min=40 min as a time required for actual shooting. For this reason, even when the viewer moves a pointer icon used to designate a frame to be played back to a position of 38/40×58 min on the sequence bar so as to start viewing from a position of 38 min from a shooting start timing, he or she cannot designate a desired frame. In practice, in order to start playback from that position, since that position has to be converted into a playback time, that is, 34 min+120 fps×(38 min−34 min)/30 fps=50 min, the viewer has to move the pointer icon to a position of 50/58×58 min=50 min.

That is, when moving image data including a range captured at a different shooting frame rate is to be played back, no existing playback apparatus sets a time required to capture the moving image data as a maximum elapsed time of the sequence bar. For this reason, it is not easy for the viewer to play back moving image data from a frame specified by a time from the shooting start timing.

### SUMMARY OF THE INVENTION

The present invention has been made in consideration of the aforementioned conventional problems. The present invention provides a playback apparatus, which allows the user to easily select a frame corresponding to an elapsed time from a shooting start timing upon playing back moving image data including a range captured at a shooting frame rate different from a playback frame rate, a control method, and a recording medium.

The present invention in its first aspect provides a playback apparatus for playing back moving image data at a predetermined playback frame rate, comprising: an obtaining unit configured to obtain moving image data formed by connecting a plurality of partial moving images respectively captured at arbitrary shooting frame rates; a first specifying unit configured to specify a playback position of the moving image data using an elapsed time from a shooting start timing; a first identifying unit configured to identify a frame corresponding to the elapsed time from the shooting start timing, which is specified by the first specifying unit, from the moving image data by analyzing shooting frame rates and durations of respective partial moving images of the moving image data obtained by the obtaining unit; and a playback unit configured to play back the moving image data from the frame identified by the first identifying unit at the playback frame rate.

Further features of the present invention will become apparent from the following description of exemplary embodiments (with reference to the attached drawings).

### BRIEF DESCRIPTION OF THE DRAWINGS

FIG. 1 is a block diagram showing the functional arrangement of a PC 100 according to an embodiment of the present invention;

FIG. 2 is a view showing the file structure of a moving image file according to the embodiment of the present invention;

FIG. 3 is a view showing the data structure of a moving image data part 202 according to the embodiment of the present invention;

FIG. 4 is a view showing the data structure of a header part 201 according to the embodiment of the present invention;

FIG. 5 is a table showing section information of moving image data according to the embodiment of the present invention;

FIGS. 6A and 6B are views showing a GUI of a moving image playback application according to the embodiment of the present invention;

FIG. 7 is a flowchart of playback control processing according to the embodiment of the present invention;

FIG. 8 is a flowchart of playback frame number identifying processing according to the embodiment of the present invention;

FIG. 9 is a flowchart of elapsed time identifying processing according to the embodiment of the present invention; and

FIGS. 10A and 10B are views showing other GUIs of the moving image playback application according to the embodiment of the present invention.

### DESCRIPTION OF THE EMBODIMENTS

An exemplary embodiment of the present invention will be described in detail hereinafter with reference to the drawings. Note that one embodiment to be described hereinafter will exemplify a case in which the present invention is applied to a PC which can play back moving image data including a range captured at a different frame rate as an example of a playback apparatus. However, the present invention is applicable to an arbitrary apparatus which can play back moving image data formed by connecting ranges (partial moving images) of different frame rates. In this specification, “shooting frame rate” indicates the number of frame images to be obtained per sec upon shooting of moving image data. Also, “playback frame rate” indicates the number of frame images to be read out per sec upon playing back of moving image data. In this embodiment, the following description will be given under the assumption that the playback frame rate is constant irrespective of the shooting frame rate of moving image data upon playing back of moving image data in a PC 100.

<Functional Arrangement of PC 100>

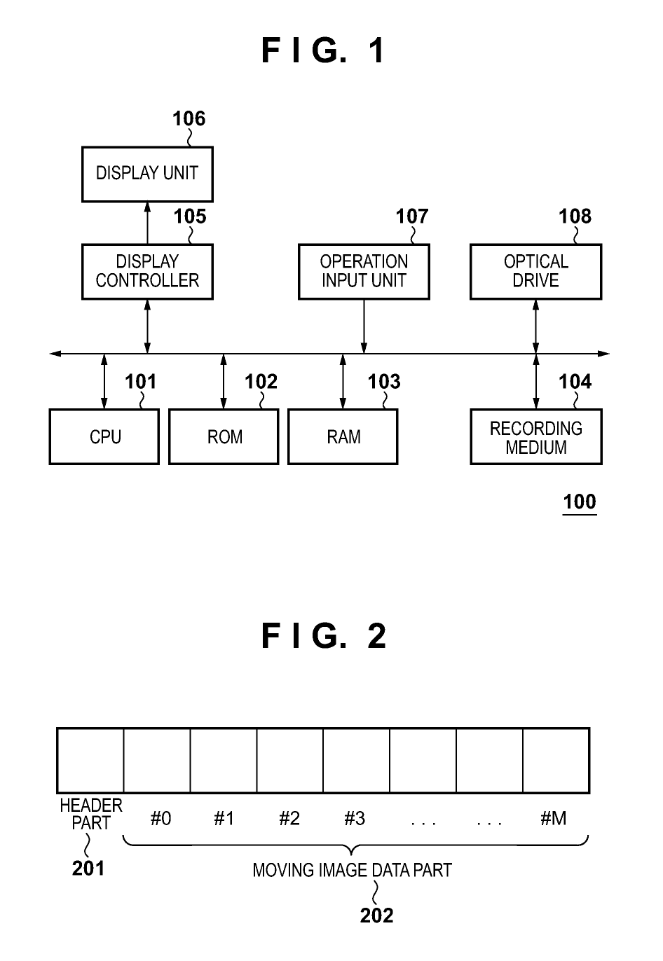

FIG. 1 is a block diagram showing the functional arrangement of a PC 100 according to an embodiment of the present invention.

A CPU 101 controls operations of respective blocks included in the PC 100. More specifically, the CPU 101 controls the operations of the respective blocks by reading out an operation program of playback control processing (to be described later) from a recording medium 104, expanding the readout program onto a RAM 103, and executing the expanded program.

A ROM 102 is, for example, a rewritable nonvolatile memory, and stores information such as parameters required for the operations of the respective blocks of the PC 100. In this embodiment, the following description will be given under the assumption that the operation program of the playback control processing (to be described later) is recorded in the recording medium 104. Alternatively, the operation program may be stored in the ROM 102 depending on the hardware configuration.

The RAM 103 is a volatile memory, and is used not only as an expansion area of the operation program of the playback control processing but also as a storage area required to temporarily store intermediate data and the like output from the respective blocks during the operations of the blocks included in the PC 100.

The recording medium 104 is, for example, a recording device such as an HDD or SSD, which is detachably connected to the PC 100. The recording medium 104 records programs related to an OS (Operating System) of the PC 100, programs of various applications, and the like in addition to the operation program of the playback control processing (to be described later).

A display controller 105 includes, for example, a GPU, and controls rendering processing of the PC 100. More specifically, the display controller 105 holds a data group for a GUI in its internal memory (not shown), and generates a display image including the GUI by superimposing the data group on, for example, frame images of moving image data upon reception of a display instruction of the CPU 101. The display image generated by the display controller 105 is displayed on a display unit 106 by the display controller 105. The display unit 106 is, for example, a display device such as an LCD, and is incorporated in the PC 100 in the description of this embodiment. Alternatively, the display unit 106 may be an external device connected to the PC 100.

An operation input unit 107 is, for example, a user interface such as a mouse and keyboard included in the PC 100, and transfers a control signal according to a user operation on that user interface to the CPU 101.

An optical drive 108 is, for example, a device having a loading function of an external recording medium such a DVD, CD-ROM, or memory card. In this embodiment, when the CPU 101 detects that an external recording medium is inserted into the optical drive 108, it reads out moving image data from the medium, and records the readout data in the recording medium 104.

<File Structure of Moving Image File>

The file structure of a moving image file recorded in the recording medium 104 in this embodiment will be described below with reference to the drawings. FIG. 2 shows the file structure of a moving image file. Moving image data includes a header part 201 and moving image data part 202.

(Structure of Moving Image Data Part 202)

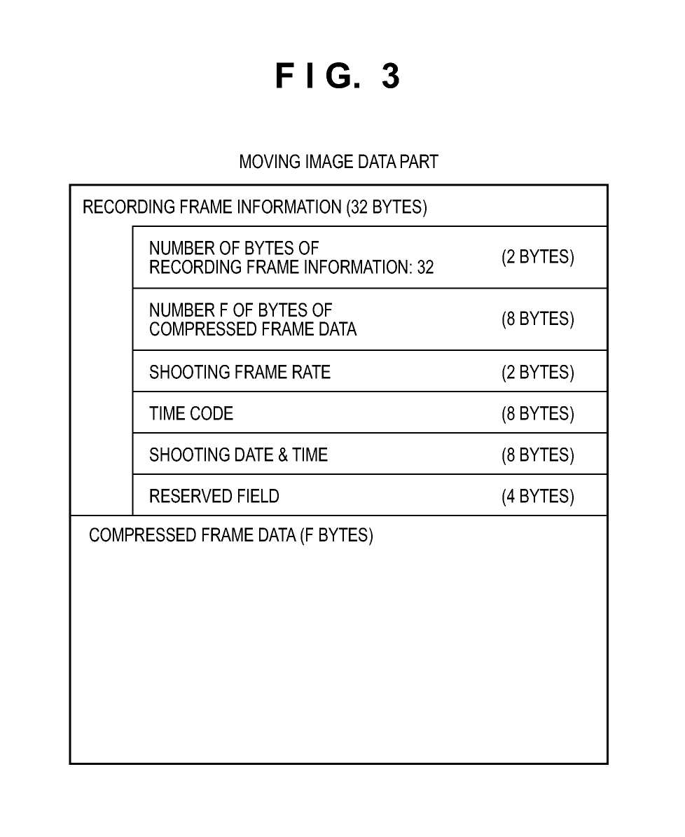

The moving image data part 202 includes data which are assigned frame numbers (#0 to #M) in turn from a first frame of moving image data, and include frame images for respective frames, as shown in FIG. 2. Information for one frame included in the moving image data part 202 may have, for example, the data structure shown in FIG. 3. In this embodiment, information for each frame of the moving image data part 202 includes compressed frame data obtained by compressing a frame image, and recording frame information including information indicating a shooting condition at the time of shooting of that frame.

The recording frame information includes:

[number of bytes of recording frame information] indicating a size of the recording frame information;

[number of bytes of compressed frame data] indicating a size of compressed frame data corresponding to a frame;

[shooting frame rate] indicating a frame rate at the time of shooting;

[time code] (unit: 1 ms) indicating an elapsed time from a shooting start timing;

[shooting date & time] (unit: 1 ms) indicating a date and time at the shooting start timing; and

[reserved field] (all bits=0) assured as a prospective assignment field.

(Structure of Header Part 201)

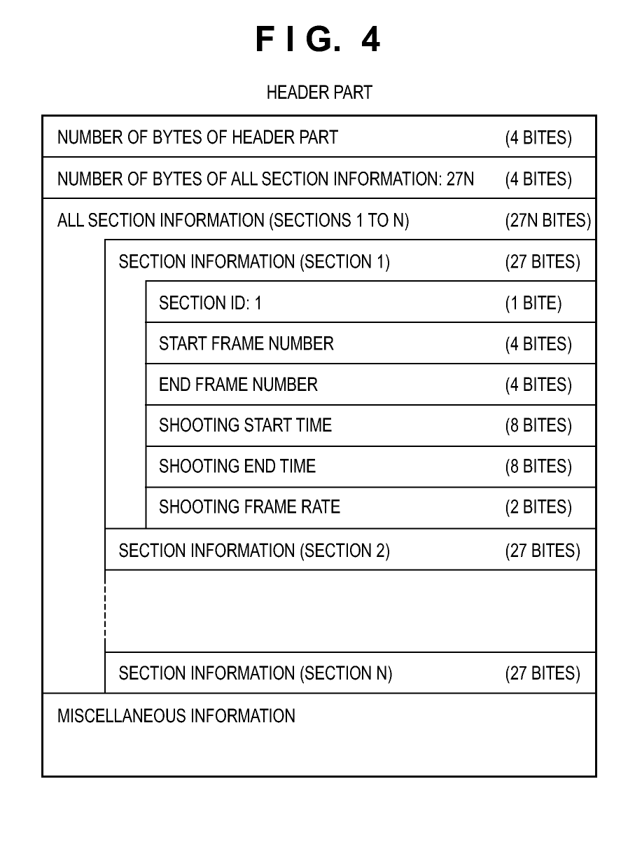

The header part 201 may have the data structure shown in FIG. 4. In this embodiment, the header part includes section information, which indicates details of each range (section) including continuous frames having the same shooting frame rate included in the aforementioned recording frame information.

The header part includes:

[number of bytes of header part] indicating a size of the header part;

[number of bytes of all section information] indicating a size required for pieces of section information of all sections of moving image data;

[all section information] including pieces of section information of respective sections; and

[miscellaneous information] including information indicating a size of the moving image data part.

The section information of one section includes:

[section ID] required to identify a section;

[start frame number] required to identify a start frame of the section;

[end frame number] required to identify an end frame of the section;

[shooting start time] (unit: 1 ms) indicating an elapsed time from a shooting start timing corresponding to the start frame of the section;

[shooting end time] (unit: 1 ms) indicating an elapsed time from a shooting end timing corresponding to the end frame of the section; and

[shooting frame rate] indicating a frequency of obtaining frames in the section.

Note that a given time period, which changes according to the shooting frame rate, is assigned to one frame, and the shooting start time and shooting end time respectively indicate time periods obtained under different conditions from time periods respectively assigned to the corresponding frames. For example, when the shooting frame rate is 120 fps, a time period of 1 s/120 fps≈8.33 ms is assigned as a corresponding time period to each frame captured at that shooting frame rate. For this reason, the shooting start time of one section means an elapsed time from the shooting start timing up to a first position of a time range corresponding to the start frame of that section. Also, the shooting end time of one section means an elapsed time from the shooting start time up to a back-end position of a time range corresponding to the end frame of that section.

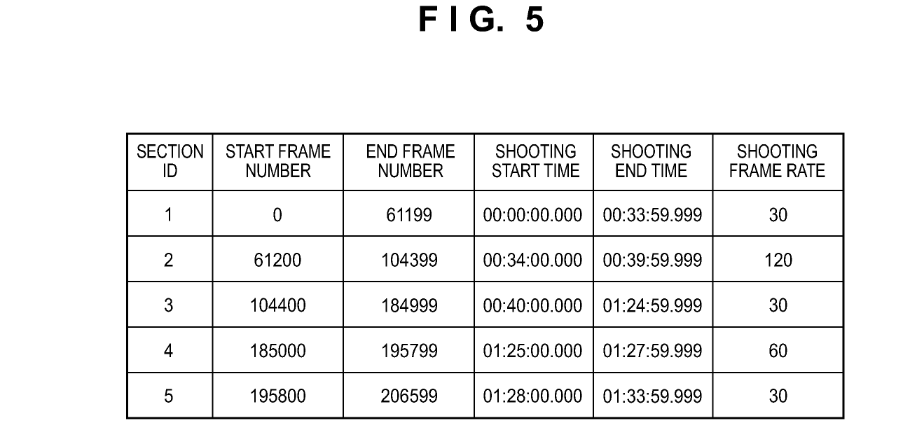

In this embodiment, moving image data having pieces of section information shown in FIG. 5 will be exemplified below. FIG. 5 is a table showing all section information of moving image data (frame numbers #0 to #206599) for 1 hour 34 min, and shows details of five sections which are separated into new sections every time the shooting frame rate is switched.

Note that the following description of this embodiment will be given under the assumption that pieces of section information are recorded in the header part 201 of moving image data upon completion of shooting of that moving image data. However, the recording timing of the pieces of section information in the header part 201 is not limited to this. For example, when moving image data is read out from an external recording medium inserted in the optical drive 108, and is transferred to the recording medium 104, the CPU 101 may analyze the moving image data to create a section information table, and may record that table in the header part 201. Alternatively, when the user inputs an edit instruction or read instruction of moving image data recorded in the recording medium 104, the CPU 101 may analyze the moving image data, and may record its section information table in the header part 201.

<Moving Image Playback Application>

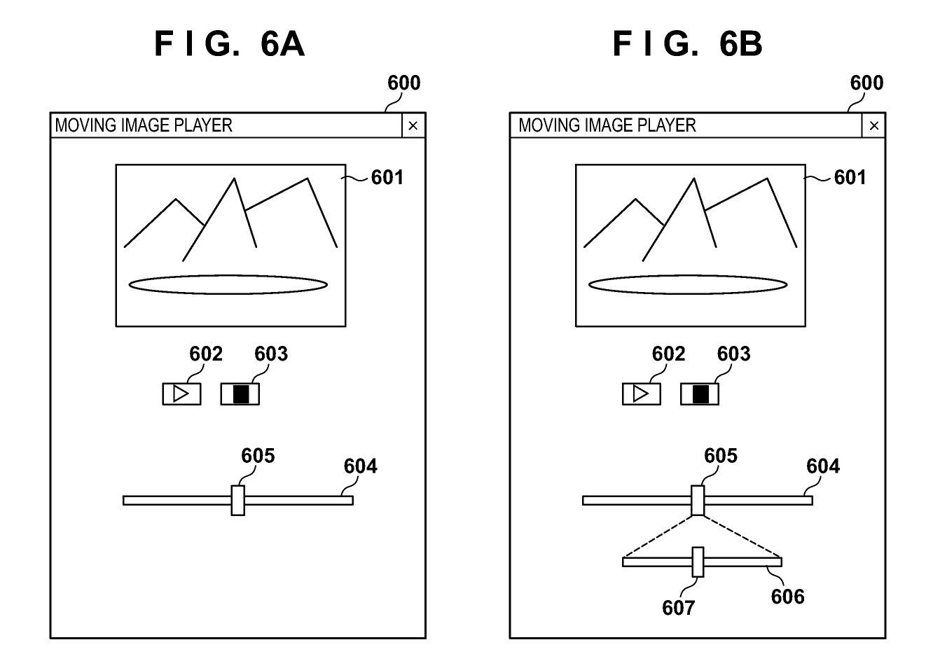

A GUI of a moving image playback application executed by the PC 100 of this embodiment will be described below. FIGS. 6A and 6B show a GUI of the moving image playback application of this embodiment.

The GUI of the moving image playback application normally has a configuration shown in FIG. 6A. An application window 600 includes a moving image area 601 which displays frame images related to moving image data, a play button 602 and stop button 603 used to input a playback start or stop instruction of the moving image data, and a sequence bar 604 indicating an elapsed time of the moving image data. Note that a pointer 605 (first pointer), which indicates a current playback position from the shooting start timing, is movably superimposed on the sequence bar 604.

In this embodiment, the sequence bar 604 indicates an elapsed time from the shooting start timing of moving image data, and a maximum elapsed time corresponds to a time required to capture the moving image data. Note that in this embodiment, when the CPU 101 detects that a point input is made to the sequence bar 604 based on a control signal output from the operation input unit 107 in response to, for example, a user's mouse operation, it changes the display screen. More specifically, the CPU 101 issues a rendering instruction to the display controller 105 so as to further display a detailed sequence bar 606 shown in FIG. 6B on the application window 600.

The detailed sequence bar 606 may display, for example, a predetermined time range to have the current playback position as the center in an enlarged scale. The user can change a playback position in more detail by moving a detailed pointer 607 movably allocated on the detailed sequence bar 606 using, for example, the mouse. Note that the range indicated by the detailed sequence bar 606 is not limited to this. For example, the range of the detailed sequence bar 606 may be set as the predetermined number of frames having the current playback frame as the center or a section including the current playback position.

<Playback Control Processing>

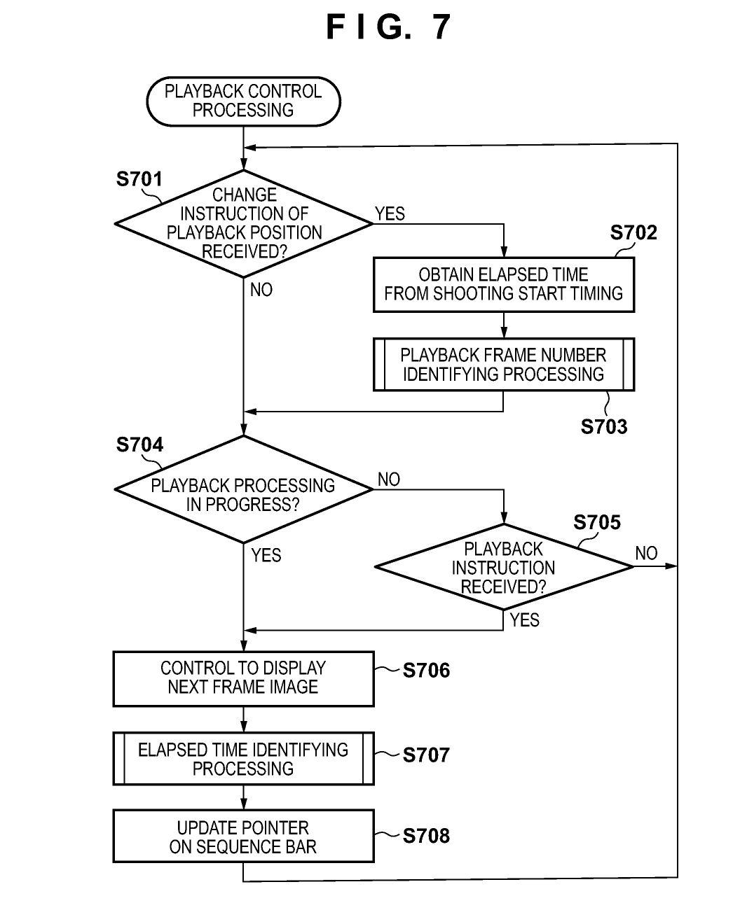

The playback control processing of the PC 100 of this embodiment having the aforementioned arrangement will be described in detail below with reference to the flowchart shown in FIG. 7. The processing corresponding to this flowchart can be implemented when the CPU 101 reads out, for example, a corresponding processing program stored in the recording medium 104, expands the readout program onto the RAM 103, and executes the expanded program. Note that the following description will be given under the assumption that this playback control processing is started when, for example, the user selects a moving image file to be played back from the moving image playback application, and that moving image file is read out from the recording medium 104 and is ready to be played back. At this time, the CPU 101 reads out a frame image of a first frame of the moving image data to be played back, and displays it on the moving image area 601.

The CPU 101 determines in step S701 whether or not the user inputs a change instruction of the playback position of the moving image data. More specifically, the CPU 101 determines whether or not a control signal, which is output from the operation input unit 107 when the user inputs a move instruction of the pointer 605 of the sequence bar 604 or the detailed pointer 607 of the detailed sequence bar 606, is received. If the CPU 101 determines that the user inputs the change instruction of the playback position, the process advances to step S702; otherwise, the process advances to step S704.

In step S702, the CPU 101 obtains an elapsed time from the shooting start timing of the moving image data, which corresponds to the changed playback position (first specifying). More specifically, the CPU 101 calculates an elapsed time from the shooting start timing corresponding to the pointer position on the sequence bar at which the user inputs the change instruction of the playback position.

In step S703, the CPU 101 executes playback frame number identifying processing for identifying a frame number (playback frame number) of the moving image data according to the calculated elapsed time from the shooting start timing corresponding to the current playback position.

(Playback Frame Number Identifying Processing)

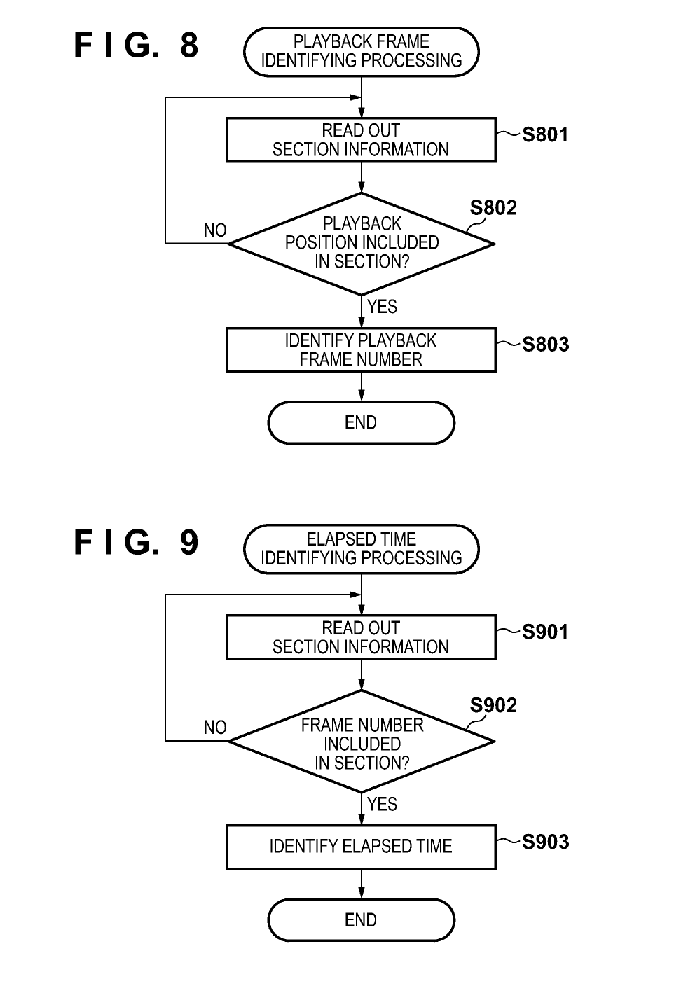

The playback frame number identifying processing for identifying a playback frame number corresponding to the current playback position will further be described below with reference to FIG. 8.

In step S801, the CPU 101 reads out section information corresponding to one section from the header part of the moving image data to be played back. As the section information to be read out, for example, information having a section ID corresponding to an integer type value (initial value 1) set as an internal variable is read out. The value of the internal variable may be a value incremented one by one when it is determined in the next process of step S802 that the section does not include the current playback position. That is, in the processes of steps S801 and S802, the CPU 101 reads out section information corresponding to each section in turn from the header part of the moving image data to be played back, and identifies a section including the current playback position.

The CPU 101 determines in step S802 with reference to information of the shooting start time and shooting end time of the section information read out in step S801 whether or not the elapsed time from the shooting start timing corresponding to the current playback position is included in a section of that section information. If the CPU 101 determines that the elapsed time from the shooting start timing corresponding to the current playback position is included in the section of the readout section information, the process advances to step S803; otherwise, the process returns to step S801.

In step S803, the CPU 101 identifies a playback frame number corresponding to the current playback position using the section information of the section including the current playback position (first identifying), thus completing this playback frame number identifying processing. More specifically, the CPU 101 calculates a playback frame number using:

(Playback frame number)=fₛₜₐᵣₜ+(t_{current}−tₛₜₐᵣₜ)×r (1)

where

fₛₜₐᵣₜ: a start frame number of the section;

t_{current}: an elapsed time from the shooting start timing corresponding to the current playback position;

tₛₜₐᵣₜ: the shooting start time of the section; and

r: the shooting frame rate of the section.

After the frame number corresponding to the current playback position is identified in this way, the CPU 101 advances the process to step S704 in the playback control processing. Note that the elapsed time from the playback start timing of the moving image data can be obtained by dividing the frame number corresponding to the current playback position by the playback frame rate set in the moving image playback application.

The CPU 101 determines in step S704 whether or not the playback processing of the moving data is currently in progress. In this embodiment, when the playback processing of the moving image data is executed in the PC 100, the CPU 101 reads out frame images of the moving image data at the playback frame rate, which is set in advance, and transfers the readout frame images to the display controller 105 to display them on the moving image area 601. In this step, the CPU 101 determines whether or not execution of processing for reading out frame images of the moving image data and transferring them to the display controller 105 is in progress. If the CPU 101 determines that the playback processing of the moving image data is in progress, it reads out a frame image corresponding to the current playback position and controls the display controller 105 to display that image on the moving image area 601, and the process then advances to step S706; otherwise, the process advances to step S705.

The CPU 101 determines in step S705 whether or not the user inputs a playback instruction of the moving image data. More specifically, the CPU 101 determines whether or not a control signal, which is output from the operation input unit 107 when the user inputs an instruction to the play button 602, is received. If the CPU 101 determines that the user inputs the playback instruction of the moving image data, the process advances to step S706; otherwise, the process returns to step S701.

In step S706, the CPU 101 reads out a frame image next to the current playback position from the recording medium 104, transfers it to the display controller 105, and controls the display controller 105 to display that frame image on the moving image area 601 according to the playback frame rate.

In step S707, the CPU 101 executes elapsed time identifying processing for identifying an elapsed time from the shooting start timing of the moving image data corresponding to a frame number of the frame image read out in step S706.

(Elapsed Time Identifying Processing)

The elapsed time identifying processing for identifying an elapsed time from the shooting start timing corresponding to the frame number will further be described below with reference to FIG. 9. Note that the following description will be given under the assumption that an elapsed time from the shooting start timing is identified based on a frame number. As is easily imagined, this processing can identify an elapsed time based on a time required for playback from a first position to a playback position of the moving image data to be played back (second specifying). In this case, the CPU 101 may execute the following processing using a frame number obtained by multiplying the time required for playback from the first position to the playback position by the predetermined playback frame rate.

In step S901, the CPU 101 reads out section information corresponding to one section from the header part of the moving image data to be played back. As the section information to be read out, information having a section ID corresponding to an integer type value (initial value 1) set as an internal variable is read out as in the frame number identifying processing. The value of the internal variable may be a value incremented one by one when it is determined in the next process of step S902 that the section does not include the frame number. That is, in the processes of steps S901 and S902, the CPU 101 reads out section information corresponding to each section in turn from the header part of the moving image data to be played back, and identifies a section including a frame number.

The CPU 101 determines in step S902 with reference to the start frame number and end frame number of the section information read out in step S901 whether or not the frame number is included in a section of the section information. If the CPU 101 determines that the frame number is included in the section of the readout section information, the process advances to step S903; otherwise, the process returns to step S901.

In step S903, the CPU 101 identifies an elapsed time from the shooting start timing of the moving image data to be played back, which corresponds to the frame number, using the section information of the section including the frame number (second identifying), thus completing this elapsed time identifying processing. More specifically, the CPU 101 calculates the elapsed time from the shooting start timing using:

(Elapsed time from shooting start timing)=tₛₜₐᵣₜ+(f_{target}−fₛₜₐᵣₜ)/r (2)

where

fₛₜₐᵣₜ: a start frame number of the section;

f_{target}: the selected frame number;

tₛₜₐᵣₜ: the shooting start time of the section; and

r: the shooting frame rate of the section.

After the elapsed time from the shooting start timing corresponding to the frame number is identified in this way, the CPU 101 advances the process to step S708 in the playback control processing.

In step S708, the CPU 101 transfers information of the elapsed time from the shooting start timing corresponding to the frame number next to the current playback position, which time is obtained by the elapsed time identifying processing in step S707, to the display controller 105. Then, the CPU 101 controls the display controller 105 to generate a display image in which the rendering positions of the pointer 605 on the sequence bar 604 and the detailed pointer 607 on the detailed sequence bar 606 are changed to the position corresponding to the elapsed time, and to display the generated image on the display unit 106. Upon completion of the process of this step, the CPU 101 returns the process to step S701.

In this manner, the user can browse moving image data together with the sequence bar indicating the elapsed time from the shooting start timing. Since the user can arbitrarily change the playback position using the sequence bar indicating the elapsed time from the shooting start timing, he or she can play back the moving image data from a frame corresponding to a desired elapsed time from the shooting start timing.

Note that in the description of this embodiment, the sequence bar 604 or detailed sequence bar 606, which allows the user to specify a playback position of moving image data using an elapsed time from the shooting start timing of that moving image data is displayed. However, the present invention is not limited to such specific embodiment.

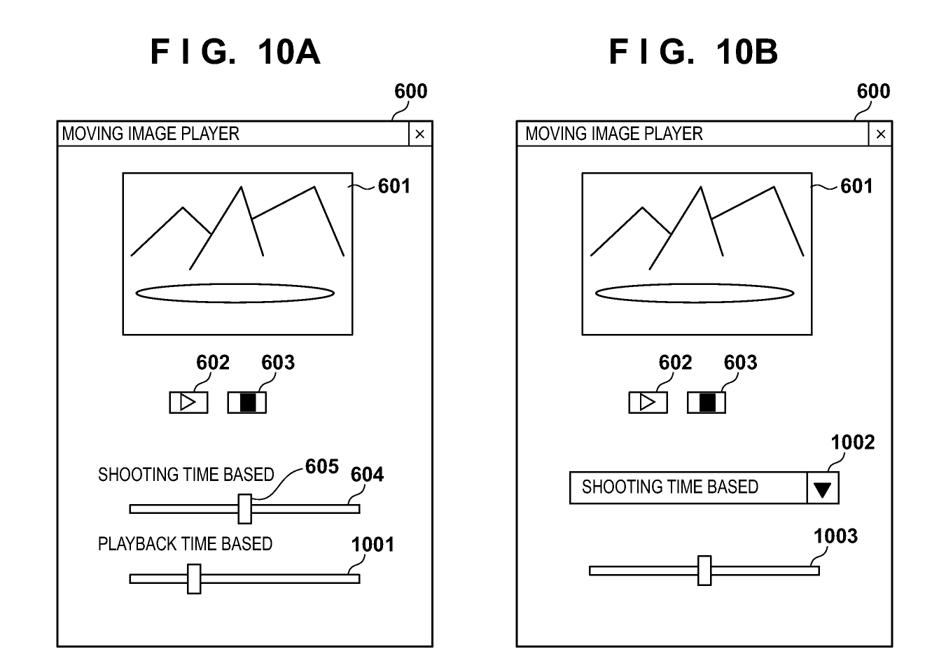

For example, as shown in FIG. 10A, in addition to the sequence bar 604 which indicates an elapsed time from the shooting start timing, a playback sequence bar 1001 which indicates a playback time from a first position of moving image data may be displayed in association with the moving image data to be played back. In this case, the user can change the playback position of the moving image data using both the elapsed time from the shooting start timing and the playback time of the moving image data. Note that the elapsed time from the shooting start timing corresponding to the playback time of the moving image data (a time indicated by a second pointer) is obtained when the CPU 101 executes the aforementioned elapsed time identifying processing.

Also, for example, as shown in FIG. 10B, a configuration which allows the user to switch the sequence bar 604 which indicates the elapsed time from the shooting start timing, and the playback sequence bar 1001 indicating the playback time from the first position of moving image data in association with the moving image data to be played back may be adopted. In the example shown in FIG. 10B, the user can select a sequence bar type to be displayed using a pull-down menu 1002, and the CPU 101 displays a sequence bar 1003 according to the selection.

In the description of this embodiment, the user designates, using the pointer on the sequence bar, an elapsed time from the shooting start timing of moving image data or a playback time from the first position of the moving image data. Alternatively, in another configuration, the user may determine a playback position by directly inputting a numerical value.

As described above, the playback apparatus of this embodiment allows the user to easily select and play back a frame corresponding to an elapsed time from the shooting start timing in playback of moving image data including a range captured at a shooting frame rate different from a playback frame rate. More specifically, the playback apparatus obtains section information, which is included in obtained moving image data, and includes a shooting frame rate, information required to identify a start frame, and information of a range of an elapsed time from the shooting start timing for each section of the same shooting frame rate. When the user specifies a playback position of the moving image data using an elapsed time from the shooting start timing, the playback apparatus determines a section including the playback position using pieces of section information of respective sections. Then, the playback apparatus identifies a playback frame corresponding to the playback position from information of a range of an elapsed time of the determined section, a shooting frame rate of the section, information required to identify a start frame of the section, and the playback position.

Note that this embodiment has explained, as a target, a moving image file including information of shooting frame rates for respective frames of moving image data. However, the present invention is not limited to such specific embodiment. For example, the present invention can be practiced for a moving image file in which moving image data includes a plurality of sections having specific frame rates in place of shooting frame rates, and which includes pieces of section information for respective sections. That is, when each section is played back according to the specific frame rate from a first position of moving image data, information of a range of an elapsed time corresponding to playback of that section, the specific frame rate set for that section, and information required to identify a start frame of that section need only be included as section information.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-258216, filed Nov. 25, 2011, which is hereby incorporated by reference herein in its entirety.

What is claimed is:

1. A playback apparatus for playing back moving image data at a predetermined playback frame rate, comprising:
an obtaining unit configured to obtain moving image data formed by connecting a plurality of partial moving images respectively captured at arbitrary shooting frame rates;
a first specifying unit configured to specify a playback position of the moving image data using an elapsed time from a shooting start timing;
a first identifying unit configured to identify a frame corresponding to the elapsed time from the shooting start timing, which is specified by said first specifying unit, from the moving image data by analyzing shooting frame rates and durations of respective partial moving images of the moving image data obtained by said obtaining unit; and
a playback unit configured to play back the moving image data from the frame identified by said first identifying unit at the playback frame rate.

2. The apparatus according to claim 1, further comprising:
a second specifying unit configured to specify a playback position of the moving image data using a time required when the moving image data is played back at the playback frame rate; and
a second identifying unit configured to identify a frame corresponding to the playback position when the playback position is specified by said second specifying unit,
wherein said playback unit plays back the moving image data from a frame corresponding to the playback position identified by said second identifying unit at the playback frame rate.

3. The apparatus according to claim 2, wherein said first specifying unit displays, on a display unit, a sequence bar corresponding to a time required to capture the moving image data, and a movable first pointer allocated on the sequence bar, and specifies an elapsed time from the shooting start timing corresponding to a position of the first pointer on the sequence bar as the playback position.

4. The apparatus according to claim 3, wherein said second specifying unit displays, on the display unit, a sequence bar corresponding to a time required when the moving image data is played back at the playback frame rate, and a movable second pointer allocated on the sequence bar, and specifies an elapsed time from a playback start timing corresponding to a position of the second pointer on the sequence bar as the playback position.

5. The apparatus according to claim 4, wherein said second specifying unit changes the position of the second pointer according to the position of the first pointer changed by said first specifying unit.

6. The apparatus according to claim 4, wherein said first specifying unit changes the position of the first pointer according to the position of the second pointer changed by said second specifying unit.

7. The apparatus according to claim 1, wherein said first identifying unit obtains the durations of the respective partial moving images based on analysis of elapsed times from the shooting start timing of the respective partial moving images, analysis of the numbers of frames of the respective partial moving images, or a description of a header part of the moving image data.

8. A playback apparatus for playing back moving image data, which includes a plurality of sections each having a specific frame rate, at a predetermined playback frame rate, comprising:
an obtaining unit configured to obtain the moving image data;
a first specifying unit configured to specify a playback position of the moving image data using an elapsed time when respective sections are played back from a first position of the moving image data according to the specific frame rates corresponding to the respective sections;
a first identifying unit configured to identify a frame corresponding to the elapsed time specified by said first specifying unit from the moving image data by analyzing the specific frame rates corresponding to the respective sections and durations of the respective sections of the moving image data obtained by said obtaining unit; and
a playback unit configured to playback the moving image data from the frame identified by said first identifying unit at the playback frame rate.

9. The apparatus according to claim 8, further comprising:
a second specifying unit configured to specify a playback position of the moving image data using a time required when the moving image data is played back at the playback frame rate; and
a second identifying unit configured to identify a frame corresponding to the playback position when the playback position is specified by said second specifying unit,
wherein said playback unit plays back the moving image data from the frame corresponding to the playback position identified by said identifying unit at the playback frame rate.

10. The apparatus according to claim 9, wherein said first specifying unit displays, on a display unit, a sequence bar corresponding to a time required when all sections of the moving image data are played back at the specific frame rates corresponding to the respective sections, and a movable first pointer allocated on the sequence bar, and specifies an elapsed time corresponding to a position of the first pointer on the sequence bar as the playback position.

11. The apparatus according to claim 10, wherein said second specifying unit displays, on the display unit, a sequence bar corresponding to a time required when the moving image data is played back at the playback frame rate, and a movable second pointer allocated on the sequence bar, and specifies an elapsed time from a playback start timing corresponding to a position of the second pointer on the sequence bar as the playback position.

12. The apparatus according to claim 11, wherein said second specifying unit changes the position of the second pointer according to the position of the first pointer changed by said first specifying unit.

13. The apparatus according to claim 11, wherein said first specifying unit changes the position of the first pointer according to the position of the second pointer changed by said second specifying unit.

14. The apparatus according to claim 8, wherein said first identifying unit obtains the durations of the respective sections based on analysis of elapsed times up to the respective sections when the moving image data is played back according to the specific frame rates, analysis of the numbers of frames of the respective sections, or a description of a header part of the moving image data.

15. A control method of a playback apparatus for playing back moving image data at a predetermined playback frame rate, the method comprising:
an obtaining step of obtaining moving image data formed by connecting a plurality of partial moving images respectively captured at arbitrary shooting frame rates;
a first specifying step of specifying a playback position of the moving image data using an elapsed time from a shooting start timing;
a first identifying step of identifying a frame corresponding to the elapsed time from the shooting start timing, which is specified in the first specifying step, from the moving image data by analyzing shooting frame rates and durations of respective partial moving images of the moving image data obtained in the obtaining step; and
a playback step of playing back the moving image data from the frame identified in the first identifying step at the playback frame rate.

16. A control method of a playback apparatus for playing back moving image data, which includes a plurality of sections each having a specific frame rate, at a predetermined playback frame rate, the method comprising:
an obtaining step of obtaining the moving image data;
a first specifying step of specifying a playback position of the moving image data using an elapsed time when respective sections are played back from a first position of the moving image data according to the specific frame rates corresponding to the respective sections;
a first identifying step of identifying a frame corresponding to the elapsed time specified in the first specifying step from the moving image data by analyzing the specific frame rates corresponding to the respective sections and durations of the respective sections of the moving image data obtained in the obtaining step; and
a playback step of playback the moving image data from the frame identified in the first identifying step at the playback frame rate.

17. A computer-readable recording medium recording a program for controlling a computer to function as respective units of a playback apparatus of claim 1.
